(19) United States
(12) Patent Application Publication
(10) Pub. No.: US 2006/0208968 A1
(43) Pub. Date: Sep. 21, 2006

(54) Plasma display apparatus and driving method thereof

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics, Inc.

(21) Appl. No.: 11/368,402

(22) Filed: Mar. 7, 2006

(30) Foreign Application Priority Data
Mar. 8, 2005 (KR) 10-2005-0019382

(51) Int. Cl. G09G 3/28

(52) U.S. Cl. 345/60

(57) ABSTRACT

This document invention relates to a display device and driving method thereof, more particularly, to a plasma display apparatus for driving electrodes and driving method thereof. A plasma display apparatus according to an embodiment of the present invention comprises a plasma display panel comprising an electrode a sustain voltage source for supplying a sustain voltage to the electrode, a source capacitor for recovering energy stored in the plasma display panel and for resupplying the recovered energy to the plasma display panel and a voltage stabilizer connected between the sustain voltage source and the source capacitor, for maintaining a voltage supplied to the source capacitor at a reference voltage level. A driving method of a plasma display apparatus according to another embodiment of the present invention comprises the steps of supplying a reference voltage to the source capacitor for initial driving stabilizing a voltage level supplied to the source capacitor for uniformly maintaining the supplied voltage with the reference voltage and resupplying the voltage supplied to the source capacitor to the plasma display panel.

This Nonprovisional application claims priority under 35 U.S.C. § 119 a on Patent Application No. 10-2005-0019382 filed in Korea on Mar. 8, 2005 the entire contents of which are hereby incorporated by reference.

### BACKGROUND OF THE INVENTION

1. Field of the Invention

This document relates to a display device and driving method thereof, and more particularly, to a plasma display apparatus that drives electrodes and driving method thereof.

2. Background of the Related Art

Generally, a plasma display apparatus among display devices includes a plasma display panel and a driver for operating the plasma display panel.

Recently, a various flat display devices reducing the volume and the weight which are disadvantages of cathode-ray tube CRT are developed. The flat display devices may be classified into a liquid crystal display LCD, a field emission display FED, a plasma display panel PDP and electroluminescence EL display device and so on.

Among the flat display devices, PDP is a display device using a gas discharge, being advantageous in that the manufacturing of large panel is facilitated At present, in most PDPs, a three-electrode alternating current surface discharge PDP where a scan electode and a sustain electrode are formed in a front substrate and an address electrode is formed in a rear substrate is mainly used.

The three-electrode alternating current surface-discharge PDP are drived by time-dividing a frame into a plurality of subfields. A gray scale is performed by proceeding the radiation, the number of which is proportional to weight of video data in each subfield period. The subfield is divided again into an initialization period, an address period and a sustain period for driving.

The initialization period is a period forming uniform wall charges on the discharge cell. The address period is a period where a selective address discharge is generated according to the logical value of video data. The sustain period is a period where the discharge is maintained in the discharge cell in which the address discharge is generated.

In this way, in the address discharge and the sustain discharge of the three-electrode alternating current surface-discharge PDP, it is necessary to generate a high voltage more than several hundred volt. Therefore, the energy recovery apparatus is used in order to minimize the driving power necessary for the address discharge and the sustain discharge.

FIG. 1 is a circuit diagram showing an energy recovery apparatus of a conventional plasma display panel.

Referring to FIG. 1, the energy recovery apparatusess 30, 32 of the plasma display panel proposed by Weber U.S. Pat. No. 5,081,400 are symmetrically installed across a panel capacitor Cp.

The panel capacitor Cp represents the electrostatic capacity formed between a scan electrode Y and a sustain electrode Z equivalently. In the energy recovery apparatus, a first energy recovery apparatus 30 supplies sustain pulses to the scan electrode Y. The second energy recovery apparatus 32 supplies the sustain pulse to the sustain electrode Z , while alternately operating with the first energy recovery apparatus 30.

The configuration of the energy recovery apparatus 30, 32 of the conventional plasma display panel will be illustrated with reference to the first energy recovery apparatus 30.

The first energy recovery apparatus 30 includes an inductor L connected between the panel capacitor Cp and a source capacitor Cs, a first and a second switch SW1, SW2 parallely connected between the source capacitor Cs and the inductor L, a third switch SW3 connected between the scan electrode Y and the sustain voltage source Vs of the panel capacitor Cp, and a fourth switch SW4 connected between the scan electrode Y and a ground voltage source GND of the panel capacitor Cp.

The source capacitor Cs collects and charges the voltage charged in the panel capacitor Cp in sustain discharge, resupplying the charged voltage to the panel capacitor Cp. The voltage Vs/2 corresponding to half of the sustain voltage source Vs is charged in the source capacitor Cs. The inductor L and the panel capacitor Cp form a resonance circuit.

The first switch SW1 to the fourth SW4 controls the flow of current. At this time, intrinsic diodes D1 to D4 are formed in the fourth switch SW1 to SW4. In the meantime, the fifth and the sixth diode D5, D6 installed between the first, the second switch SW1, SW2 and the inductor L prevent currents from flowing to the reverse direction.

FIG. 2 is a timing diagram and a waveform diagram showing the on/off timing of the switches shown in FIG. 1 and the output waveform of the panel capacitor.

Referring to FIG. 2, it is assumed that, before the period t1, the voltage of 0V is charged in the panel capacitor Cp, whiel the voltage of the Vs/2 is charged in the source capacitor Cs.

In the period t1, when the first switch SW1 is tuned-on, then the current path connected to the source capacitor Cs, the first switch SW1, the fifth diode D5, the inductor L and the panel capacitor Cp is formed Accordingly, the voltage of the Vs/2 charged in the source capacitor Cs is supplied to the panel capacitor Cp.

At this time, as the inductor L and the panel capacitor Cp form a series-resonant cicuit, the sustain voltage Vs corresponding to two times of the source capacitor Cs voltage is charged in the panel capacitor Cp.

In the period t2, the first switch SW1 is turned off. The third switch SW3 is turned on. Accordingly, the sustain voltage Vs is supplied to the scan electrode Y from the sustain voltage source Vs. At this time, the panel capacitor Cp maintains the sustain voltage Vs during the period t2.

In the meantime, as the voltage of the panel capacitor Cp is increased to the sustain voltage Vs in the period t1, the driving power which is supplied from outside for a sustain discharge is minimized.

In the period t3, the third switch SW3 is turned off The second switch SW2 is turned on. Accordingly, the current path connected to the panel capacitor Cp, the inductor L, the sixth diode D6 and the source capacitor Cs is formed so that the voltage charged in the panel capacitor Cp is collected to the source capacitor Cs. At this time, the voltage of the Vs/2 is charged in the source capacitor Cs.

After the period t3, the second switch SW3 is a turned off. The fourth switch SW4 is turned on. Accordingly, the ground voltage GND is supplied to the scan electrode Y of the panel capacitor Cp. At this time, the panel capacitor Cp maintains the ground voltage GND when the sustain pulse is supplied to the sustain electrode Z.

In the meantime, the second energy recovery apparatus 32 supplies the sustain pulse to the panel capacitor Cp while alterately operating with the first energy recovery apparatus 30.

Therefore, the sustain voltage Vs having the opposite polarity is supplied to the panel capacitor Cp. Since the sustain voltage Vs having the opposite polarity is supplied to the panel capacitor Cp, the sustain discharge occurs in discharge cells.

However, in the conventional energy recovery apparatus, since the voltage supplied to the source capacitor Cs does not exist, the voltage drop is generated according to the impedance of the scan electrode Y side when the charging/discharging of the sustain voltage Vs is performed in the panel capacitor Cp.

Hence, the voltage smaller than ½ sustain voltage Vs/2 is charged in the source capacitor Cs. Accordingly, the voltage smaller than the sustain voltage Vs is charged in the panel capacitor C such that the reliability is lowered.

In addition, the voltage difference between the sustain voltage Vs and the voltage charged in source capacitor Cs is applied to the first switch and the second switch SW1, SW2., which leads to raise the rating of the first and the second switch SW1, SW2. Thus, there is a problem in that the cost of the plasma display panel increases.

### SUMMARY OF THE INVENTION

Accordingly, an object of an embodiment of the present invention is to solve at least the problems and disadvantages of the background art.

The present invention is to provide a plasma display apparatus and driving method thereof which can decrease the cost with improving the reliability.

A plasma display apparatus according to an embodiment of the present invention comprises a plasma display panel comprising an electrode, a sustain voltage source for supplying a sustain voltage to the electrode, a source capacitor for recovering energy stored in the plasma display panel and for resupplying the recovered energy to the plasma display panel and a voltage stabilizer connected between the sustain voltage source and the source capacitor, for maintaining a voltage supplied to the source capacitor at a reference voltage level.

A plasma display apparatus according to another embodiment of the present invention comprises a plasma display panel comprising an electrode, a sustain voltage source for supplying a sustain voltage to the electrode, a source capacitor for recovering energy stored in the plasma display panel for resupplying the recovered energy to the plasma display panel, a first voltage stabilizer connected between the sustain voltage source and the source capacitor for maintaining a voltage supplied to the source capacitor at a reference voltage level and a second voltage stabilizer connected between the source capacitor and a base voltage source for maintaining a voltage supplied to the source capacitor at a reference voltage level.

A driving method of a plasma display apparatus according to still another embodiment of the present invention comprises the steps of supplying a reference voltage to the source capacitor for initial driving, stabilizig a voltage level supplied to the source capacitor for uniformly maintaining the supplied voltage with the reference voltage and reupplying the voltage supplied to the source capacitor to the plasma display panel.

The present invention, by using a voltage stabilizing part, maintains the rising time of the sustain voltage which is charged in the panel capacitor to improve the reliability by steadily charging the reference voltage to the source capacitor.

The present invention can use a switch element having a low withstanding such that it can decrease the cost of the plasma display apparatus.

### BRIEF DESCRIPTION OF THE DRAWINGS

The invention will be described in detail with reference to the following drawings in which like numerals refer to like elements.

FIG. 1 is a circuit diagram showing an energy recovery apparatus of a conventional plasma display panel.

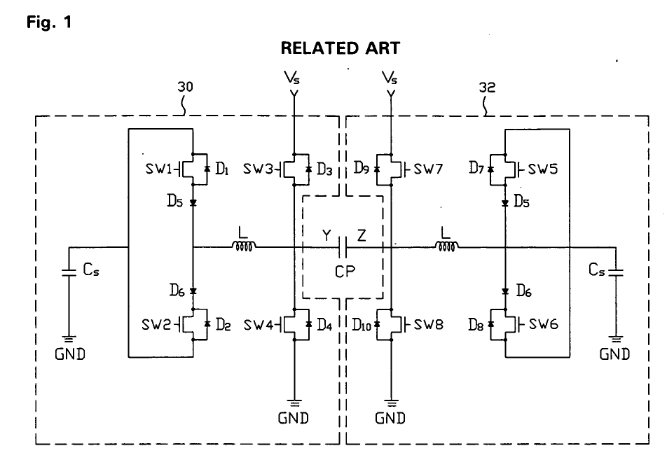

FIG. 2 is a timing diagram and a waveform diagram showing the on/off timing of the switches shown in FIG. 1 and the output waveform of the panel capacitor.

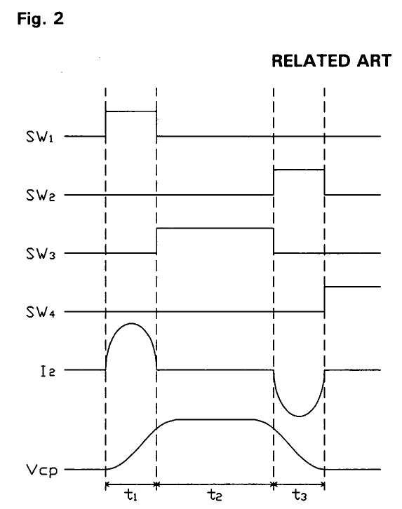

FIG. 3 is a drawing showing a plasma display apparatus according to an embodiment of the present invention.

FIG. 4 is a drawing showing an energy recovery apparatus of the plasma display panel according to another embodiment of the present invention.

### DETAILED DESCRIPTION OF PREFERRED EMBODIMENTS

Embodiments of the present invention will be described in a more detailed manner with reference to the drawings.

A plasma display apparatus according to an embodiment of the present invention comprises a plasma display panel comprising an electrode, a sustain voltage source for supplying a sustain voltage to the electrode, a source capacitor for recovering energy stored in the plasma display panel and for resupplying the recovered energy to the plasma display panel and a voltage stabilizer connected between the sustain voltage source and the source capacitor, for maintaining a voltage supplied to the source capacitor at a reference voltage level.

The voltage stabilizer is a constant voltage source.

The voltage stabilizer comprises a zener diode connected between the sustain voltage source and the source capacitor.

The reference voltage level substantially equals a half of the sustain voltage.

The apparatus further comprises a resistor connected between the zener diode and the sustain voltage source for controlling a current supplied to the zener diode.

A plasma display apparatus according to another embodiment of the present invention comprises a plasma display panel comprising an electrode, a sustain voltage source for supplying a sustain voltage to the electrode, a source capacitor for recovering energy stored in the plasma display panel for resupplying the recovered energy to the plasma display panel a first voltage stabilizer connected between the sustain voltage source and the source capacitor for maintaining a voltage supplied to the source capacitor at a reference voltage level and a second voltage stabilizer connected between the source capacitor and a base voltage source for maintaining a voltage supplied to the source capacitor at a reference voltage level.

The first and second voltage stabilizers are constant voltage sources.

The first voltage stabilizer comprises a first zener diode connected between the sustain voltage source and the source capacitor.

The reference voltage level substantially equals a half of the sustain voltage.

The first voltage stabilizer further comprises a first resistor connected between the first zener diode and the sustain voltage source for controlling a current supplied to the first zener diode.

The second voltage stabilizer comprises a second zener diode connected between the source capacitor and the base voltage source.

The reference voltage level substantially equals a half of the sustain voltage.

The second voltage stabilizer further comprises a second resistor connected between the source capacitor and the second zener diode for controlling a current flowing to the second zener diode.

A driving method of a plasma display apparatus according to still another embodiment of the present invention comprises the steps of supplying a reference voltage to the source capacitor for initial driving stabilizing a voltage level supplied to the source capacitor for uniformly maintaining the supplied voltage with the reference voltage and resupplying the voltage supplied to the source capacitor to the plasma display panel.

The reference voltage level substantially equals a half of a sustain voltage.

Detailed embodiments of the present invention will now be described in connection with reference to the accompanying drawings.

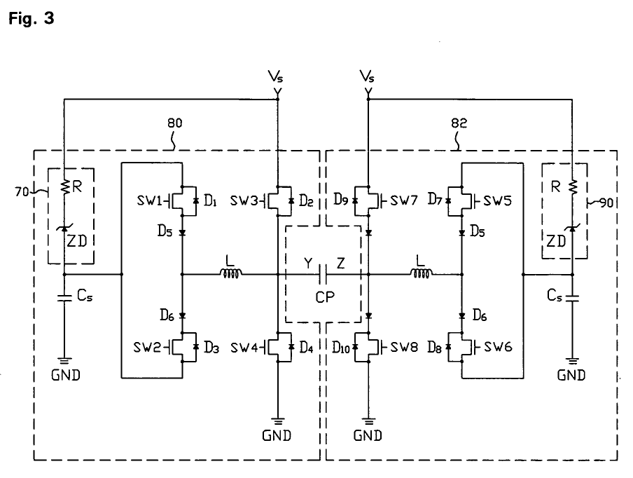

FIG. 3 is a drawing showing a plasma display apparatus according to an embodiment of the present invention.

As shown in FIG. 3, the energy recovery apparatus 80, 82 among the plasma display apparatus according to the embodiment of the present invention are symmetrically installed across a panel capacitor Cp.

The panel capacitor Cp shows the electrostatic capacity formed between the scan electrode Y and the sustain electrode Z equivalently.

The first energy recovery apparatus 80 supplies the sustain pulse to the scan electrode Y. The second energy recovery apparatus 82 supplies the sustain pulse to the sustain electrode Z, while alternately operting with the first energy recovery apparatus 80.

The configuration of the energy recovery apparatus 80, 82 of the plasma display panel according to the embodiment of the present invention will be illustrated with reference to the first energy recovery apparatus 80.

The first energy recovery apparatus 80 comprises a sustain voltage source Vs for supplying a sustain voltage Vs to the scan electrode Y of the panel capacitor Cp, a ground voltage source GND for supplying the ground voltage GND to the scan electrode Y of the panel capacitor Cp, the source capacitor Cs for collecting the energy charged in the panel capacitor Cp and re-supplying the collected energy to the panel capacitor Cp, and an inductor L connected between the panel capacitor Cp and the source capacitor Cs.

Moreover, it includes a first and a second switch SW1, SW2 parallely connected between the inductor L and the source capacitor Cs, a first diode D1 connected between the first switch SW1 and the inductor L, a second diode D2 connected between the inductor L and the second switch SW2 , a third switch SW3 connected between the sustain voltage source Vs and the scan electrode Y of the panel capacitor Cp, a fourth switch SW4 connected between the scan electrode Y and the ground voltage source GND of the panel capacitor Cp, and the voltage stabilizing part 70 connected between the sustain voltage source Vs and the source capacitor Cs.

The panel capacitor Cp shows the electrostatic capacity formed between the scan electrode Y and the sustain electrode Z of PDP equivalent1y.

The panel capacitor Cp generates a sustain discharge by the sustain voltage Vs having the opposite polarity.

The source capacitor Cs collects the energy charged in the panel capacitor Cp and re-supplies the collected energy to the scan electrode Y of the panel capacitor Cp.

The inductor L stores the energy supplied from the panel capacitor Cp by the switching control signal of the first switch to the fourth switch SW1 to SW4, supplying the energy stored by an LC resonance with the panel capacitor Cp to the panel capacitor Cp.

The first switch SW1, connected between the source capacitor Cs and the first diode D1, forms a current path so that the energy stored in the source capacitor Cs c an be supplied to the panel capacitor Cp by a first switching control signal supplied from the timing controller(not shown).

The second switch SW2, connected between the source capacitor Cs and the second diode D2, forms a current path so that the energy of the reactive power which does not contribute to a discharge in the panel capacitor Cp can be supplied to the source capacitor Cs by a second switching control signal supplied from the timing controller(not shown).

The third switch SW3, connected between the sustain voltage source Vs and the scan electrode Y of the panel capacitor Cp, forms a current path so that the sustain voltage Vs from the sustain voltage source Vs can be supplied to the scan electrode Y of the panel capacitor Cp by a third switching control signal supplied from the timing controller(not shown).

The fourth switch SW4, connected between the scan electrode Y of the panel capacitor Cp and the ground voltage source GND, forms a current path so that the ground voltage GND from the ground voltage source GND can be supplied to the scan electrode Y of the panel capacitor Cp by a fourth switching control signal supplied from the timing controller(not shown).

Each of the first to the fourth switch SW1 to SW4 is comprised of a semiconductor switch device, for example, one of MOSFET, IGBT, SCR, and BJT.

The first diode D1, connected between the first switch SW1 and the inductor L, prevents a reverse current from the panel capacitor Cp in the charge of the panel capacitor Cp.

The second diode D2, connected between the inductor L and the second switch SW2, prevents a reverse current from the source capacitor Cs in the discharge of the panel capacitor Cp.

The voltage stabilizing part 70, connected between the sustain voltage source Vs and the source capacitor Cs, stabilizes the voltage supplied from the sustain voltage source Vs so that the voltage supplied to the source capacitor Cs can be maintained with the reference voltage although current is changed in the first energy recovery apparatus 80 by the change of the load.

The voltage stabilizing part 70 comprises a resistance R and a Zener diode ZD serially connected between the sustain voltage source Vs and the source capacitor Cs.

It is desirable that the reference voltage is ½ sustain voltage ½ Vs, hereinafter, an exemplary embodiment will be illustrated on the condition that the reference voltage is ½ sustain voltage ½ Vs.

The resistance R, connected between the sustain voltage source Vs and Zener diode ZD, controls the current flowing in the Zener diode ZD.

The Zener diode ZD, connected between the resistance R and source capacitor Cs, is used as a constant voltage source having ½ sustain voltage Vs so that the source capacitor Cs can be steadily supplied with ½ sustain voltage Vs among the sustain voltage Vs supplied from the sustain voltage source Vs.

The Zener diode ZD employs a device which can constantly maintain the reference voltage. Accordingly, ½ sustain voltage Vs is always steadily charged in the source capacitor Cs.

In the meantime, the second energy recovery apparatus 82 supplies the driving voltage to the sustain electrode Z of the panel capacitor Cp, while alternately operating with the first energy recovery apparatus 80.

Therefore, the sustain voltage Vs having the opposite polarity is supplied to the panel capacitor Cp.

In this way, being the sustain voltage Vs having the opposite polarity supplied to the panel capacitor Cp, the sustain discharge occurs in discharge cells.

The voltage stabilizing part 90 installed in the second energy recovery apparatus 82 plays the same role as the voltage stabilizing part 70 installed in the first energy recovery apparatus 80, hence, the detailed description will be abbreviated.

In the energy recovery apparatus among the plasma display apparatus according to the embodiment of the present invention, the voltage stabilizing part 70 is set up between the sustain voltage source Vs and the source capacitor Cs to maintain the voltage supplied to the source capacitor Cs with ½ sustain voltage Vs/2 . Thus, ½ sustain voltage Vs/2 can be steadily charged to the source capacitor Cs.

Therefore, the rising time of the sustain voltage Vs which is charged in the panel capacitor Cp can be uniformly maintained, so that the reliability can be improved.

Moreover, since ½ sustain voltage Vs/2 is steadily charged to the source capacitor Cs, ½ ½ sustain voltage Vs/2 is steadily charged to the first and the second switch SW1, SW2 which forms a charge/discharge current path of the panel capacitor Cp. Thus, a switch element having a low withstanding can be used, which leads to the decrease of cost.

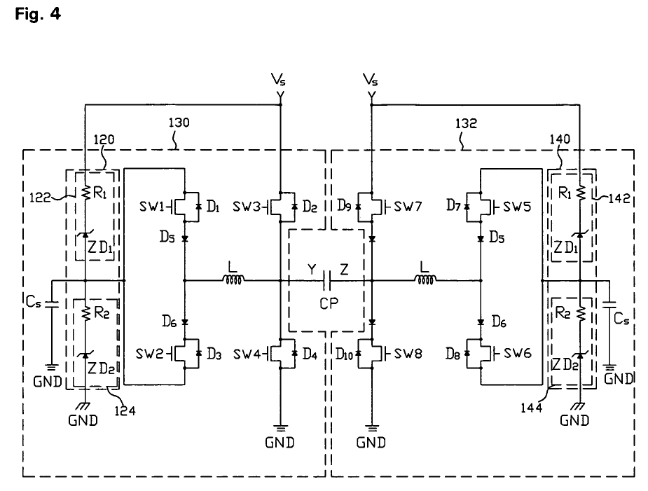

FIG. 4 is a drawing showing an energy recovery apparatus of the plasma display panel according to another embodiment of the present invention.

As shown in FIG. 4, an energy recovery apparatus 130, 132 among the plasma display apparatus according to another embodiment of the present invention are symmetrically installed across a panel capacitor Cp.

The panel capacitor Cp represents the electrostatic capacity formed between a scan electrode Y and a sustain electrode Z equivalently.

A first energy recovery apparatus 130 supplies sustain pulses to the scan electrode Y. A second energy recovery apparatus 132 supplies sustain pulses to the sustain electrode Z, while alternately operating with the first energy recovery apparatus 130.

The configuration of energy recovery apparatus 130, 132 among the plasma display apparatus according to another embodiment of the present invention will be illustrated with reference to the first energy recovery apparatus 130.

The first energy recovery apparatus 130 includes a sustain voltage source Vs for supplying a sustain voltage Vs to the scan electrode Y of the panel capacitor Cp, a ground voltage source GND for supplying the ground voltage GND to the scan electrode Y of the panel capacitor Cp, a source capacitor Cs for collecting the energy charged in the panel capacitor Cp and re-supplying the collected energy to the panel capacitor Cp, and a inductor L connected between the panel capacitor Cp and source capacitor Cs.

Moreover, it includs a first and a second switch SW1, SW2 parallely connected between the inductor L and the source capacitor Cs, a first diode D1 connected between the first switch SW1 and the inductor L, a second diode D2 connected between the inductor L and the second switch SW2, a third switch SW3 connected between the scan electrode Y of the panel capacitor Cp and the sustain voltage source Vs, a fourth switch SW4 connected between the scan electrode Y of the panel capacitor Cp and the ground voltage source GND, a first voltage stabilizing part 122 connected between the sustain voltage source Vs and the source capacitor Cs and a second voltage stabilizg part 124 connected between the source capacitor Cs and the ground voltage source GND.

In compared with the energy recovery apparatus of the plasma display panel according to the embodiment of FIG. 3, the energy recovery apparatus of the plasma display panel according to the another embodiment of the present invention may be similar to the energy recovery apparatus of the plasma display panel according to the embodiment of the present invention except the second voltage stabilizing part 124. Hence, the detailed description except the second voltage stabilizing part 124 will be abbreviated.

The second voltage stabilizing part 124 is connected between the source capacitor Cs and the ground voltage source GND, stabilizng the voltage divided by the first voltage stabilizing part 122 so that the voltage supplied to the source capacitor Cs can maintain ½ sustain voltage ½ Vs although a current is changed in the first energy recovery apparatus 130 due to the change of the load.

That is, the second voltage stabilizing part 124 stabilizes the voltage divided by the first voltage stabilizing part 122 so that the voltage which is stabilized by the first voltage stabilizing part 122, or ½ sustain voltage Vs/2 might be steadily supplied to the both ends of the source capacitor Cp.

The second voltage stabilizing part 124 includes a second resistance R2 serially connected between the source capacitor Cs and the ground voltage source GND and a second Zener diode ZD2.

The second resistance R2 is connected between the source capacitor Cs and the ground voltage source GND, controlling the current flowing in the second Zener diode ZD2. The second resistance R2 can be removed.

The second Zener diode ZD2 is connected between the second resistance R2 and the ground voltage source GND, being used as a constant voltage source having ½ sustain voltage Vs/2 so that ½ sustain voltage Vs/2 divided by the first voltage stabilizing part 122 might be steadily supplied to the both ends of the source capacitor Cs.

The same device as the first Zener diode ZD1 is used for the second Zener diode ZD.

In other words, the device which can maintain ½ sustain voltage Vs/2 uniformly is used for the second Zener diode ZD2. Accordingly, ½ sustain voltage Vs/2 is always steadily charged to the source capacitor Cs.

In this way, in the energy recovery apparatus of the plasma display panel according to another embodiment of the present invention, the voltage stabilizing part 120 is installed between the sustain voltage source Vs and the source capacitor Cs and the ground voltage source GND to uniformly maintain the voltage supplied to the source capacitor Cs with ½ sustain voltage Vs/2 such that ½ sustain voltage Vs/2 can be steadily charged to the source capacitor Cs.

Therefore, since the rising time of the sustain voltage Vs which is charged in the panel capacitor Cp can be uniformly maintained, the reliability can be improved.

Moreover, since ½ sustain voltage Vs/2 is steadily charged to the source capacitor Cs, ½ sustain voltage Vs/2 is steadily applied to the first and the second switch SW1, SW2 that forms the charge/discharge current path of the panel capacitor Cp, thereby the switch element having a low withstanding can be used. Thus, the cost of the plasma display panel can be decreased.

Accordingly, as the source capacitor is steadily charged with the reference voltage by using the voltage stabilzing part, the rising time of the sustain voltage which is charged in the panel capacitor can be uniformly maintained, thereby the reliability can be improved

Moreover, the switch element having a low withstanding can be used, which result in the decease of the cost of the plasma display apparatus.

The invention being thus described, it will be obvious that the same may be varied in many ways. Such variations are not to be regarded as a depaure from the spirit and scope of the invention, and all such modifications as would be obvious to one skilled in the art are intended to be included within the scope of the following claims.

What is claimed is:

1. A plasma display apparatus comprising:
a plasma display panel comprising an electrode;
a sustain voltage source for supplying a sustain voltage to the electrode;
a source capacitor for recovering energy stored in the plasma display panel and for resupplying the recovered energy to the plasma display panel; and
a voltage stabilizer connected between the sustain voltage source and the source capacitor, for maintaining a voltage supplied to the source capacitor at a reference voltage level.

2. The apparatus of claim 1, wherein the voltage stabilizer is a constant voltage source.

3. The apparatus of claim 2, wherein the voltage stabilzer comprises a zener diode connected between the sustain voltage source and the source capacitor.

4. The apparatus of claim 3, wherein the reference voltage level substantially equals a half of the sustain voltage.

5. The apparatus of claim 3, further comprising a resistor connected between the zener diode and the sustain voltage source for controlling a current supplied to the zener diode.

6. A plasma display apparatus comprising:
a plasma display panel comprising an electrode;
a sustain voltage source for supplying a sustain voltage to the electrode;
a source capacitor for recovering energy stored in the plasma display panel for resupplying the recovered energy to the plasma display panel;
a first voltage stabilizer connected between the sustain voltage source and the source capacitor for maintaining a voltage supplied to the source capacitor at a reference voltage level; and
a second voltage stabilizer connected between the source capacitor and a base voltage source for maintaining a voltage supplied to the source capacitor at a reference voltage level.

7. The apparatus of claim 6, wherein the first and second voltage stabilizers are constant voltage sources.

8. The apparatus of claim 7, wherein the first voltage stabilizer comprises a first zener diode connected between the sustain voltage source and the source capacitor.

9. The apparatus of claim 8, wherein the reference voltage level substantially equals a half of the sustain voltage.

10. The apparatus of claim 8, wherein the first voltage stabilizer further comprises a first resistor connected between the first zener diode and the sustain voltage source for controlling a current supplied to the first zener diode.

11. The apparatus of claim 7, wherein the second voltage stabilizer comprises a second zener diode connected between the source capacitor and the base voltage source.

12. The apparatus of claim 11, wherein the reference voltage level substantially equals a half of the sustain voltage.

13. The apparatus of claim 11, wherein the second voltage stabilizer further comprises a second resistor connected between the source capacitor and the second zener diode for controlling a current flowing to the second zener diode.

14. A driving method of a plasma display apparatus, the method comprising the steps of:
supplying a reference voltage to the source capacitor for initial driving;
stabilizing a voltage level supplied to the source capacitor for uniformly maintaining the supplied voltage with the reference voltage; and
resupplying the voltage supplied to the source capacitor to the plasma display panel.

15. The method of claim 14, wherein the reference voltage level equals substantially a half of a sustain voltage.
